(19) United States
(12) Patent Application Publication
(10) Pub. No.: US 2013/0033138 A1
(43) Pub. Date: Feb. 7, 2013

(54) Spindle motor

(71) Applicant: Chang Jo Yu, Suwon (KR)

(72) Inventor: Chang Jo Yu, Suwon (KR)

(73) Assignee: Samsung Electro-Mechanics Co., Ltd., Suwon (KR)

(21) Appl. No.: 13/317,931

(22) Filed: Nov. 1, 2011

(30) Foreign Application Priority Data
Aug. 2, 2011 (KR) 10-2011-0077007

(51) Int. Cl. H02K 5/16; F16C 32/06

(52) U.S. Cl. 310/90; 384/100; 384/110

(57) ABSTRACT

There is provided a spindle motor including: a shaft fixedly coupled to a base member; a stationary unit coupled to the shaft so as to be disposed over the base member; and a sleeve member forming a bearing clearance with the stationary unit to be filled with lubricating fluid, wherein the stationary unit includes a plurality of stationary members and the plurality of stationary members are disposed to be opposed to each other while being spaced apart from each other by a predetermined interval so as to have the lubricating fluid interposed therebetween, the stationary members including a liquid-vapor interface formed therebetween.

### CROSS-REFERENCE TO RELATED APPLICATIONS

This application claims the priority of Korean Patent Application No. 10-2011-0077007 filed on Aug. 2, 2011, in the Korean Intellectual Property Office, the disclosure of which is incorporated herein by reference.

### BACKGROUND OF THE INVENTION

1. Field of the Invention

The present invention relates to a spindle motor, and more particularly, to a spindle motor in which a shaft is fixedly installed.

2. Description of the Related Art

A fixed shaft type spindle motor, in which a shaft having strong impact resistance is fixed to a case of a hard disk driving device, is generally mounted in an information recording and reproducing device such as a hard disk driving device for a server, or the like.

That is, a fixed type shaft is fixedly installed in the spindle motor mounted in the hard disk driving device for a server in order to prevent information stored in the server from being damaged and or being unrecordable/unreadable due to an external impact.

As described above, when the fixed type shaft is installed, two sleeves, two fixed members, two covers for shielding upper and lower portions of the fixed members, and the like, are generally required in order to configure a hydrodynamic bearing assembly filled with lubricating fluid. In other words, a large number of components are required in order to configure the hydrodynamic bearing assembly including the fixed type shaft. Since a large number of components are required in order to configure the hydrodynamic bearing assembly as described above, a manufacturing cost thereof increases.

In addition, a bearing clearance formed by two sleeves and two fixed members is generally separated into an upper bearing clearance and a lower bearing clearance. When lubricating fluid is injected into the separated bearing clearances, different amounts of lubricating fluid may be injected into the separated bearing clearances. In this case, the lubricating fluid may be depleted in early stage due to an evaporation in a bearing clearance into which a small amount of lubricating fluid has been injected.

In this case, there is no method for supplementing the lubricating fluid in the bearing clearance in which the lubricating fluid is depleted due to the evaporation. As a result, a lifespan of a motor may be reduced due to a shortage of the lubricating fluid filling either bearing clearance.

### SUMMARY OF THE INVENTION

An aspect of the present invention provides a spindle motor in which a reduction in a lifespan thereof due to an evaporation of lubricating fluid may be suppressed.

Another aspect of the present invention provides a spindle motor of which manufacturing costs may be reduced.

According to an aspect of the present invention, there is provided a spindle motor including: a shaft fixedly coupled to a base member; a stationary unit coupled to the shaft so as to be disposed over the base member; and a sleeve member forming a bearing clearance with the stationary unit to be filled with lubricating fluid, wherein the stationary unit includes a plurality of stationary members and the plurality of stationary members are disposed to be opposed to each other while being spaced apart from each other by a predetermined interval so as to have the lubricating fluid interposed therebetween, the stationary members including a liquid-vapor interface formed therebetween.

The stationary unit may include a first stationary member coupled to an upper portion of the shaft and a second stationary member coupled to the shaft in such a manner as to be spaced apart from the first stationary member by a predetermined interval to thereby form a clearance to be filled with the lubricating fluid.

The first and second stationary members may have a shape in which they are symmetrical with respect to each other based on the clearance.

The first and second stationary members may include a sealing surface inclined such that the liquid-vapor interface is formed at one side of the clearance.

Each of the first and second stationary members may include a communication groove communicating between a space formed by the sealing surface and the outside to thereby form the liquid-vapor interface.

The first and second stationary members may include circulation holes formed therein, the circulation holes communicating between the clearance formed by the first and second stationary members and the bearing clearance formed by the first and second stationary members and the sleeve member to thereby allow for a circulation of the lubricating fluid.

The first and second stationary members may include inclination surfaces provided on outer peripheral surfaces thereof in order to increase bearing rigidity in an axial direction and a radial direction, and the first and second stationary members may have a conical shape.

The first stationary member may include a first chamfer part so as to form a first liquid-vapor interface different from the liquid-vapor interface formed by the sleeve member and the first and second stationary members, and the second stationary member may include a second chamfer part so as to form a second liquid-vapor interface different from the liquid-vapor interface formed by the sleeve member and the first and second stationary members, and the first liquid-vapor interface formed by the first stationary member and the sleeve member.

The sleeve member may include: a first sleeve member forming the bearing clearance together with the first stationary member and having the first stationary member disposed inwardly thereof; and a second sleeve member disposed under the first sleeve member, forming the bearing clearance together with the second stationary member, and having the second stationary member disposed inwardly thereof.

The spindle motor may further include a rotor hub fixedly coupled to an outer peripheral surface of the sleeve member to thereby rotate together with the sleeve member.

The rotor hub may include a magnet mounting part having a magnet installed on an inner peripheral surface thereof and extended downwardly in an axial direction.

The base member may include a coupling part having a stator core fixedly coupled thereto and a sidewall part disposed to be spaced apart from the coupling part and forming an installation groove together with the coupling part, and the magnet mounting part is insertedly disposed in the installation groove.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view of a spindle motor according to an embodiment of the present invention;

FIG. 2 is an enlarged view of part A of FIG. 1; and

FIG. 3 is a partially cut-away exploded perspective view showing a stationary unit and a sleeve member according to an embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but these are to be construed as being included in the spirit of the present invention.

Further, when it is determined that a detailed description of the known art related to the present invention may obscure the gist of the present invention, a detailed description thereof will be omitted.

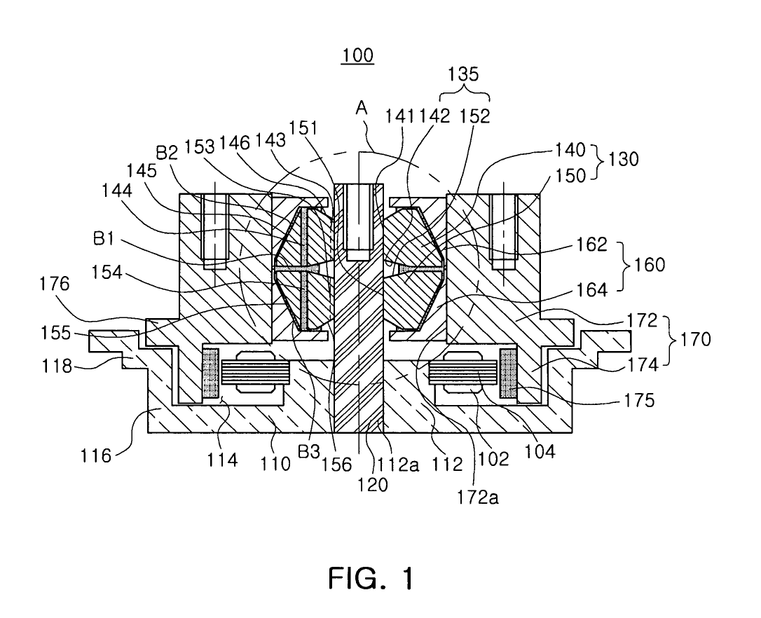

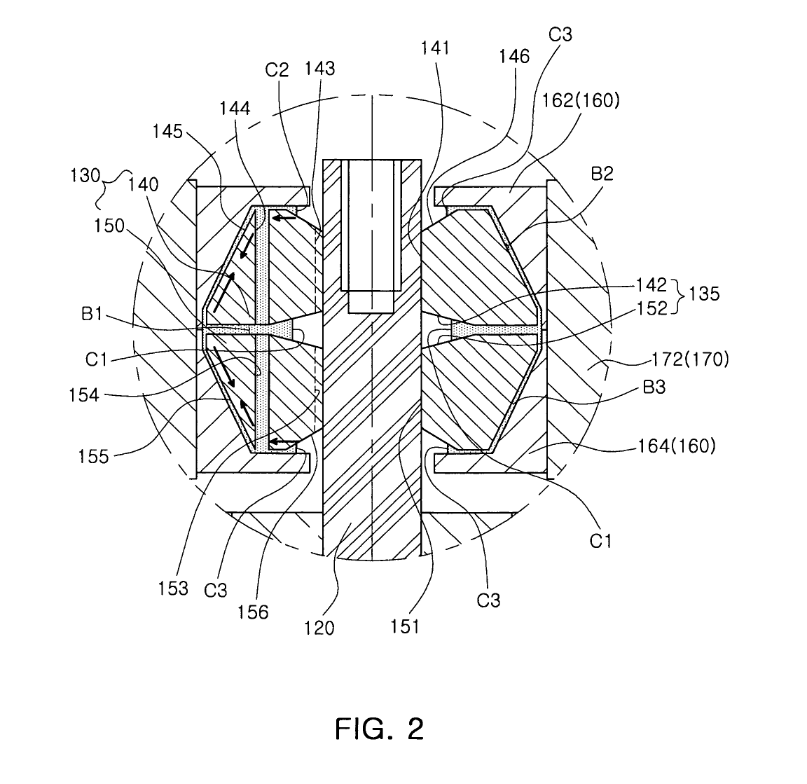

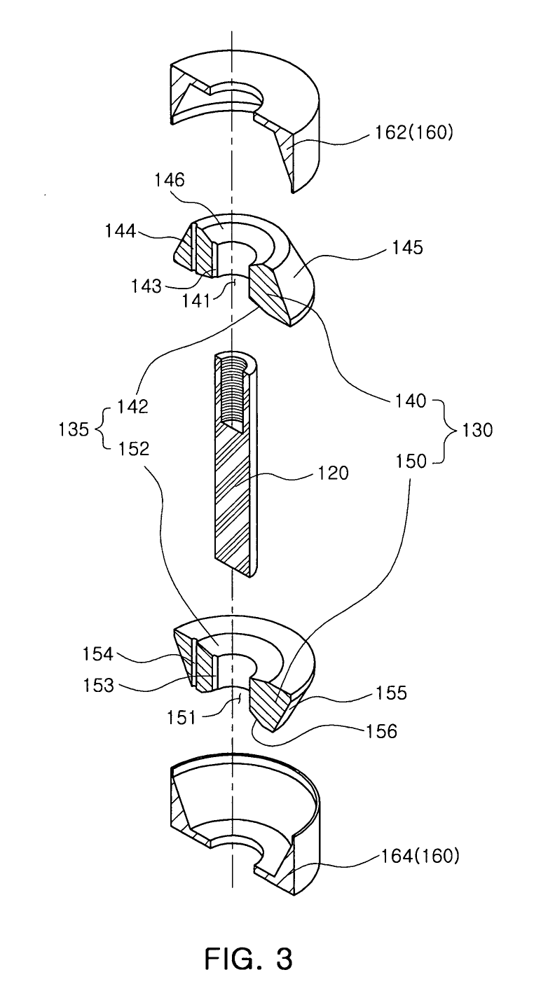

FIG. 1 is a schematic cross-sectional view of a spindle motor according to an embodiment of the present invention. FIG. 2 is an enlarged view of part A of FIG. 1. FIG. 3 is a partially cut-away exploded perspective view showing a stationary unit and a sleeve member according to an embodiment of the present invention.

Referring to FIGS. 1 and 3, a spindle motor 100 according to an embodiment of the present invention may include, for example, a base member 110, a shaft 120, a stationary unit 130, a sleeve member 160, and a rotor hub 170.

Here, terms with respect to directions will be defined. As viewed in FIG. 1, an axial direction refers to a direction from an upper lower portion of the shaft 120 toward a lower portion thereof or a direction from the lower portion of the shaft 120 toward the upper portion thereof, an inner radial direction or an outer radial direction refers to a direction from an outer peripheral surface of the rotor hub 170 toward the shaft 120 or a direction from shaft 120 toward the outer peripheral surface of the rotor hub 170, and a circumferential direction refers to a rotation direction along the outer peripheral surface of the rotor hub 170.

The base member 110 may include a coupling part 112 having an installation hole 112a formed therein, the installation hole 112a including the shaft 120 insertedly installed therein. That is, the shaft 120 may be fixedly coupled to the installation hole 112a while being inserted therein.

Meanwhile, the coupling part 112 may include a stator core 104 fixedly coupled to an outer peripheral surface thereof, the stator core 104 having a coil 102 wound therearound.

In addition, the base member 110 may include a sidewall part 116 disposed to be spaced apart from the coupling part 112 by a predetermined interval and forming an installation groove 114 together with the coupling part 112.

Meanwhile, the base member 110 may include a step part 118 disposed in the outer radial direction from the sidewall part 116 and having a shape corresponding to a shape of the rotor hub 170.

The shaft 120 has a lower end portion inserted into the installation hole 112a formed in the coupling part 112 and may be fixedly coupled to the base member 110. In addition, the shaft 120 may have a cylindrical shape of which a diameter thereof in an upper portion thereof is the same as that in a lower portion thereof.

The stationary unit 130 may be coupled to the shaft 120 so as to be disposed over the base member 110. In addition, the stationary unit 130 may include a plurality of stationary members, and the plurality of stationary members are disposed to be opposed to each other while being spaced apart from each other by a predetermined interval so as to allow lubricating fluid to be interposed between the stationary members disposed to be opposed each other. Here, the stationary members disposed to be opposed to each other may include a liquid-vapor interface formed therebetween.

That is, the stationary unit 130 may include a first stationary member 140 coupled to an upper portion of the shaft 120 and a second stationary member 150 coupled to the shaft 120 so as to be spaced apart from the first stationary member 140 by a predetermined interval and to form a clearance to be filled with the lubricating fluid.

More specifically, the first and second stationary members 140 and 150 are fixedly coupled to the shaft 120 in such a manner that they are disposed to be spaced apart from each other by a predetermined interval. In addition, the first and second stationary members 140 and 150 may include the liquid-vapor interface formed therebetween.

That is, a lower surface of the first stationary member 140 and an upper surface of the second stationary member 150 include a clearance B1 formed therebetween, and the clearance B1 has the lubricating fluid filled therein. In addition, an interface between the filled lubricating fluid and the air, that is, a liquid-vapor interface C1 may be formed at one side of the clearance B1.

Meanwhile, the first stationary member 140 may include a first through-hole 141 formed in the center thereof so as to be fixedly coupled to the shaft 120, the first through-hole 141 including the shaft 120 penetrating therethrough. In addition, the second stationary member 150 may also include a second through-hole 151 formed in the center thereof, the second through-hole 151 including the shaft 120 penetrating therethrough.

Further, the first and second stationary members 140 and 150 may include a sealing surface 135 inclined such that the liquid-vapor interface C1, that is, the interface between the lubricating fluid and air, maybe formed at one side of the clearance B1 described above.

The sealing surface 135 may include a first sealing surface 142 formed in the first stationary member 140, and the first sealing surface 142 maybe formed in the first stationary member 140 so as to be disposed at a lower end portion of the first through-hole 141.

In addition, the sealing surface 135 may include a second sealing surface 152 formed in the second stationary member 150, and the second sealing surface 152 may be formed in the second stationary member 150 so as to be disposed at an upper end portion of the second through-hole 151.

Further, the first and second sealing surfaces 142 and 152 may be inclined. That is, the first sealing surface 142 may be inclined upwardly based on the lower surface of the first stationary member 140, and the second sealing surface 152 may be inclined downwardly based on the upper surface of the second stationary member 150.

In addition, the first and second stationary members 140 and 150 may have a shape in which they are symmetrical with respect to each other, based on the clearance B1. In other words, the first and second stationary members 140 and 150 may have the same shape and may have a shape in which they are coupled to the shaft 120 in such a manner that respective upper portions and respective lower portions thereof are simply inverted with respect to each other to thereby be symmetrical, based on the clearance B1.

In addition, the respective first and second stationary members 140 and 150 may include communication grooves 143 and 153 communicating between a space formed by the sealing surface 135 and the outside to thereby form the liquid-vapor interface C1.

In other words, when the first and second stationary members 140 and 150 are coupled to the shaft 120, a predetermined space is formed by an outer peripheral surface of the shaft 120 and the first and second sealing surfaces 142 and 152 of the first and second stationary members 140 and 150. In addition, in order to form the interface between the lubricating fluid and air, that is, the liquid-vapor interface C1, pressure in the predetermined interface space is required to be at the same level as that of external pressure.

To this end, the first and second stationary members 140 and 150 include the communication grooves 143 and 153 formed in inner surfaces thereof so as to be in communication with the outside. Therefore, the interface between the lubricating fluid and air, that is, the liquid-vapor interface C1, may be formed between the first and second sealing surfaces 142 and 152 of the first and second stationary members 140 and 150.

Meanwhile, the first and second stationary members 140 and 150 may include circulation holes 144 and 154 formed therein. A detailed description of the circulation holes 144 and 154 will be provided below.

In addition, the first and second stationary members 140 and 150 may include inclination surfaces 145 and 155 provided on outer peripheral surfaces thereof in order to increase bearing rigidity. In other words, the first and second stationary members 140 and 150 may have a conical shape.

In addition, the first stationary member 140 may include a first chamfer part 146 so as to form a first liquid-vapor interface C2 different from the liquid-vapor interface C1 formed by the sleeve member 160 and the first and second stationary members 140 and 150.

That is, the first stationary member 140 may include the first chamfer part 146 in such a manner that the first liquid-vapor interface C2 may be formed at an upper end portion of the first through-hole 141 of the first stationary member 140.

In addition, the second stationary member 150 may include a second chamfer part 156 so as to form a second liquid-vapor interface C3 different from the liquid-vapor interface C1 formed by the sleeve member 160 and the first and second stationary members 140 and 150 and the first liquid-vapor interface C2 formed by the first stationary member 140 and the sleeve member 160.

That is, the second stationary member 150 may include the second chamfer part 156 so as to form the liquid-vapor interface C3 different from the liquid-vapor interface C1 and the first liquid-vapor interface C2. In addition, the second chamfer part 156 may be disposed at a lower end portion of the through-hole 151 formed in the second stationary member 150.

Meanwhile, the sleeve member 160 may form bearing clearances B2 and B3 together with the stationary unit 130 such that the lubricating fluid may be filled.

That is, the sleeve member 160 may include a first sleeve member 162 forming the bearing clearance B2 together with the first stationary member 140 and having the first stationary member 140 disposed inwardly thereof. In addition, the sleeve member 160 may include a second sleeve member 164 disposed under the first sleeve member 162, forming the bearing clearance B3 together with the second fixed stationary member 150, and having the second stationary member 150 disposed inwardly thereof.

To this end, the first and second sleeve members 162 and 164 may have inner shapes in which the first and second stationary members 140 and 150 may be insertedly disposed therein.

In addition, the sleeve member 160, a rotating member rotating together with the rotor hub 170 at the time of the rotation of the rotor hub 170, may more stably rotate by fluid dynamic pressure formed through the lubricating fluid filled in the bearing clearances B2 and B3.

In addition, the first and second sleeve members 162 and 164 may also have a shape in which they are symmetrical with respect to each other based on the clearance B1 formed by the first and second stationary members 140 and 150.

Meanwhile, the circulation holes 144 and 154 formed in the first and second stationary members 140 and 150 may serve to communicate between the clearance B1 formed by the first and second stationary members 140 and 150, and the bearing clearances B2 and B3 and eventually allow for the circulation of the lubricating fluid filled in the clearance B1 and the bearing clearances B2 and B3.

Therefore, a defect in which different amounts of lubricating fluid are injected into the bearing clearances B2 and B3 may be prevented at the time of manufacturing of the spindle motor. In addition, since the bearing clearances B2 and B3 are in communication with each other, the local depletion of the lubricating fluid due to an evaporation may be prevented, whereby a deterioration in performance may be reduced.

In addition, since the liquid-vapor interface C1 may also be formed in the clearance B1 formed between the first and second stationary members 140 and 150, a flow space in which the lubricating fluid may flow may be increased even in the case of an external impact, whereby leakage of the lubricating fluid due to the external impact may be reduced.

Here, interface formation positions, at which interfaces between the lubricating fluid filling the clearance B1 and the bearing clearance B2 and B3 and air are formed, will be described. First, the liquid-vapor interface C1 is formed by the first and second stationary members 140 and 150. In addition, the first liquid-vapor interface C2 is formed by the first stationary member 140 and the first sleeve member 162. Further, the second liquid-vapor interface C3 is formed by the second stationary member 150 and the second sleeve member 164.

In other words, the first liquid-vapor interface C2, the liquid-vapor interface C1, and the second liquid-vapor interface C3 may be sequentially disposed from the upper portion of the shaft 120 toward the lower portion thereof.

The rotor hub 170 is fixedly coupled to an outer peripheral surface of the sleeve member 160 to thereby rotate together with the sleeve member 160. Meanwhile, the rotor hub 170 may include a cylindrical body 172 having a mounting hole 172a formed in the center thereof so as to have the sleeve member 160 insertedly installed therein and a magnet mounting part 174 extended downwardly from the body 172 in the axial direction.

In addition, the magnet mounting part 174 may include a magnet 175 fixedly installed on an inner peripheral surface thereof. Meanwhile, the magnet mounting part 174 is insertedly disposed in the installation groove 114 formed by the coupling part 112 and the sidewall part 116 included in the base member 110.

Therefore, a leading edge of the stator core 104 coupled to the coupling part 112 of the base member 110 may be disposed to face the magnet 175 installed on the magnet mounting part 174.

Hereinafter, a rotational driving mechanism of the rotor hub 170 will be simply described.

First, as described above, the stator core 104 having the coil 102 wound therearound may be coupled to the coupling part 112 of the base member 110 and disposed to face the magnet 175 installed on the magnet mounting part 174.

The magnet 175 may have an annular ring shape and be a permanent magnet generating magnetic force having a predetermined strength by alternately magnetizing a north (N) pole and a south (S) pole in the circumferential direction.

Meanwhile, when power is supplied to the coil 102 wound around the stator core 104, driving force capable of rotating the rotor hub 170 is generated by electromagnetic interaction between the magnet 175 and the stator core 104 having the coil 102 wound therearound.

Therefore, the rotor hub 170 rotates and at this time, the sleeve member 160 fixedly coupled to the rotor hub 170 also rotates together with the rotor hub 170.

In addition, the rotor hub 170 may further include a disk installation part 176 extended in the outer radial direction from the body 172 and having a plurality of disks disposed on an upper portion thereof.

As described above, three interfaces between the lubricating fluid and air are formed through the stationary unit 130 including the first and second stationary members 140 and 150, whereby leakage of the lubricating fluid may be reduced.

That is, since the lubricating fluid filling the bearing clearances B2 and B3 flows in the clearance B1 formed by the first and second stationary members 140 and 150 at the time of the rotation of the rotor hub 170, the leakage of the lubricating fluid may be difficult to thereby suppress the leakage of the lubricating fluid.

In order words, since the interface between the lubricating fluid and air, that is, the liquid-vapor interface C1 is also formed in the clearance B1 formed by the first and second stationary members 140 and 150, even in the case the lubricating fluid leaks through the liquid-vapor interface C1 formed in the clearance B1, the leaked lubricating fluid re-flows immediately to the bearing clearance B1, whereby leakage of the lubricating fluid to the outside may be reduced.

In addition, since all of the clearance B1 and the bearing clearances B2 and B3 filled with the lubricating fluid, may be in communication with each other, a defect in which different amounts of lubricating fluid are injected into the bearing clearances B2 and B3 may be prevented at the time of manufacturing of the spindle motor, in contrast with a case in which upper and lower bearing clearances are separated from each other. Further, since the bearing clearances B2 and B3 are in communication with each other, the local depletion of the lubricating fluid due to an evaporation may be prevented, whereby a deterioration in performance may be reduced.

In addition, since a hydrodynamic bearing may be configured to include the stationary unit 130 and the sleeve member 160, the number of components may be reduced, whereby manufacturing costs of the spindle motor may be reduced.

Furthermore, the rotor hub 170 may be floated at a predetermined height during the rotation thereof. In this case, the bearing clearance B2 formed by the first stationary member 140 and the first sleeve member 162 may be widened.

Therefore, the installation of a pulling plate generating force which is directed downwardly in the axial direction may be faciliated. As a result, bearing rigidity in the first stationary member 140 may be increased.

That is, vibrations generated in the first stationary member 140 may be suppressed.

As set forth above, according to the embodiment of the present invention, three interfaces between lubricating fluid and air are formed through the stationary unit including a plurality of stationary members, whereby leakage of lubricating fluid may be reduced.

In addition, since all of the bearing clearances filled with the lubricating fluid may be in communication with each other, even in the case that the lubricating fluid filling any one of upper and lower bearing clearances is evaporated under high temperature environments, a reduction in a lifespan of the spindle motor due to the evaporation of the lubricating fluid may be suppressed, in contrast with a case in which upper and lower bearing clearances are separated from each other.

Further, the number of components is reduced, whereby manufacturing costs of the spindle motor may be reduced.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a shaft fixedly coupled to a base member;
a stationary unit coupled to the shaft so as to be disposed over the base member; and
a sleeve member forming a bearing clearance with the stationary unit to be filled with lubricating fluid,
wherein the stationary unit includes a plurality of stationary members and the plurality of stationary members are disposed to be opposed to each other while being spaced apart from each other by a predetermined interval so as to have the lubricating fluid interposed therebetween, the stationary members including a liquid-vapor interface formed therebetween.

2. The spindle motor of claim 1, wherein the stationary unit includes a first stationary member coupled to an upper portion of the shaft and a second stationary member coupled to the shaft in such a manner as to be spaced apart from the first stationary member by a predetermined interval to thereby form a clearance to be filled with the lubricating fluid.

3. The spindle motor of claim 2, wherein the first and second stationary members have a shape in which they are symmetrical with respect to each other based on the clearance.

4. The spindle motor of claim 2, wherein the first and second stationary members include a sealing surface inclined such that the liquid-vapor interface is formed at one side of the clearance.

5. The spindle motor of claim 4, wherein each of the first and second stationary members includes a communication groove communicating between a space formed by the sealing surface and the outside to thereby form the liquid-vapor interface.

6. The spindle motor of claim 2, wherein the first and second stationary members include circulation holes formed therein, the circulation holes communicating between the clearance formed by the first and second stationary members and the bearing clearance formed by the first and second stationary members and the sleeve member to thereby allow for a circulation of the lubricating fluid.

7. The spindle motor of claim 2, wherein the first and second stationary members include inclination surfaces provided on outer peripheral surfaces thereof in order to increase bearing rigidity in an axial direction and a radial direction, and the first and second stationary members have a conical shape.

8. The spindle motor of claim 7, wherein the first stationary member includes a first chamfer part so as to form a first liquid-vapor interface different from the liquid-vapor interface formed by the sleeve member and the first and second stationary members, and the second stationary member includes a second chamfer part so as to form a second liquid-vapor interface different from the liquid-vapor interface formed by the sleeve member and the first and second stationary members, and the first liquid-vapor interface formed by the first stationary member and the sleeve member.

9. The spindle motor of claim 2, wherein the sleeve member includes:
a first sleeve member forming a bearing clearance together with the first stationary member and having the first stationary member disposed inwardly thereof; and
a second sleeve member disposed under the first sleeve member, forming a bearing clearance together with the second stationary member, and having the second stationary member disposed inwardly thereof.

10. The spindle motor of claim 1, further comprising a rotor hub fixedly coupled to an outer peripheral surface of the sleeve member to thereby rotate together with the sleeve member.

11. The spindle motor of claim 10, wherein the rotor hub includes a magnet mounting part having a magnet installed on an inner peripheral surface thereof and extended downwardly in an axial direction.

12. The spindle motor of claim 11, wherein the base member includes a coupling part having a stator core fixedly coupled thereto and a sidewall part disposed to be spaced apart from the coupling part and forming an installation groove together with the coupling part, and
the magnet mounting part is insertedly disposed in the installation groove.
